(19) United States
(12) Patent Application Publication
(10) Pub. No.: US 2026/0207994 A1
(43) Pub. Date: Jul. 23, 2026

(54) Golf range lighting system

(71) Applicant: Exled Ltd., Stonehouse Gloucestershire (GB)

(72) Inventors: Mark Caster, Oviedo, FL (US); Michael Renecle, Stonehouse Gloucestershire (GB); Mark Ruthers, Stonehouse Gloucestershire (GB); Matthew Towell, Oviedo, FL (US)

(21) Appl. No.: 19/453,230

(22) Filed: Jan. 20, 2026

Related U.S. Application Data
(60) Provisional application No. 63/747,464, filed on Jan. 21, 2025.

(51) Int. Cl. A63B 24/00; A63B 67/02; A63B 69/36; A63B 71/06; F21V 21/14; H05B 47/115

(52) U.S. Cl. CPC A63B 24/0021; A63B 67/02; A63B 69/3694; F21V 21/14; H05B 47/115; A63B 2024/0034; A63B 71/0616; A63B 2220/807; A63B 2220/89; A63B 2225/50; A63B 2225/74

(57) ABSTRACT

A golf range lighting system that includes a plurality of lighting units controllable through a tablet interface with wireless communication capabilities. The lighting units comprise LED arrays with variable intensity and color output, housed in weather-resistant enclosures with optional positioning mechanisms. The system enables remote control of lighting parameters including power state, dimming, positioning, and color selection through a secure wireless network with mesh capabilities. API integration allows connection with ball tracking technology and bay management software, enabling automated control based on ball trajectory data and bay status indication through color coding. Multiple embodiments provide varying levels of positioning control including vertical and horizontal adjustment capabilities. The system includes comprehensive monitoring, diagnostic, and safety features ensuring reliable operation in various environmental conditions.

### FIELD

The present invention relates to lighting systems for golf ranges, and more particularly to a lighting system with integrated tablet control, wireless communication capabilities, and application programming interface (API) integration for ball tracking and bay management.

### BACKGROUND

Golf ranges typically include lighting only for nighttime operations. These conventional lighting systems known in the art provide basic illumination but lack advanced control features and integration capabilities with modern tracking and management systems. Traditional systems typically employ fixed position lights with manual controls, limiting their utility and adaptability.

Golf driving ranges face challenges in player engagement and revenue generation beyond basic range fees. Traditional prize games and competitions require manual administration, physical verification of results, and significant overhead for prize management. Existing automated systems, where present, typically operate independently from facility lighting and tracking infrastructure, creating operational complexity and limiting interactive possibilities.

There exists a need for an improved golf range lighting system offering enhanced control, tracking integration, and management features, optionally coupled with prizes for particular results.

### SUMMARY

The golf range lighting system addresses the limitations of prior art systems by providing a system with a plurality of lights, a tablet or mobile control interface, wireless communication capabilities, and API integration. The system enables remote control of lighting parameters including power state, dimming, positioning, and color selection. Integration with ball tracking and bay management systems provides enhanced functionality for golf range operations.

The lighting control system uses a wireless mesh network architecture where each lighting unit acts as both a receiver and a signal repeater. This configuration enables reliable control across extended distances as control signals propagate through the network of lights. A central server coordinates all communication, processing commands from tablet or mobile interfaces and routing the commands to the appropriate lighting units. The mesh network provides redundant communication paths, ensuring system reliability even if individual network nodes become unavailable.

The light fixtures are available in multiple embodiments. Some are fixed, others include positioning systems. For the embodiments that include positioning, the mechanical positioning systems provide precise control over light direction through a combination of vertical and horizontal adjustments. In the vertical plane, servo motors enable tilt adjustment of individual light modules mounted on a support arm. In the horizontal plane, a motorized base enables rotation of the entire lighting assembly. Each movement axis includes position feedback sensors and memory capabilities, allowing operators to store and recall specific lighting configurations for different usage scenarios.

The API framework enables integration with existing golf range infrastructure. When connected to ball tracking systems, the lighting system can respond to shot detection and trajectory data, illuminating targets or activating special lighting effects based on shot accuracy or distance achievements. The API further interfaces with bay management software, using light color and patterns to indicate bay status, reservation information, and time remaining. These integrations create an interactive experience where lighting responds dynamically to player actions and facility operations.

The system optionally includes an integrated hole-in-one jackpot game that uses the existing lighting and ball tracking infrastructure. Players enroll in the game through a user interface at their assigned hitting bay. The system monitors each enrolled player's shots using the range tracking technology to determine whether a ball enters a designated target zone qualifying as a hole-in-one. Upon verification of a qualifying shot, the system automatically initiates a payout event, which includes issuing funds, digital credits, vouchers, or gift certificates.

The hole-in-one game optionally incorporates a progressive jackpot feature where a portion of each entry fee is added to an accumulating prize pool. The current jackpot amount is displayed through bay interfaces and integrated lighting elements. So long as a hole-in-one has not yet occurred, the jackpot continues to increase. When a hole-in-one is detected, the award is issued as described above. The system then automatically resets the prize pool to a predetermined base value and begins accumulating again for future participants. The lighting components illuminate the target area, indicate jackpot size through color and intensity variations, and provide celebratory visual effects when a winning shot is detected.

The jackpot system operates in multiple embodiments. In a first embodiment, the system uses a progressive jackpot model where each entry contributes a predetermined portion to a cumulative prize pool. In a second embodiment, the system offers fixed-payout prizes with configurable tiers based on target difficulty or distance. In a third embodiment, lighting elements change color, intensity, pattern, or sequence to indicate game status conditions including current jackpot amount, active participants, successful hole-in-one events, and jackpot reset events.

In a fourth embodiment, the system employs multi-target qualification logic where a hole-in-one is recorded upon entry into a physical receptacle, intersection with a virtual zone defined in software, contact with a sensor array, or triggering of an audio, optical, or magnetic detection system. In a fifth embodiment, the system supports multi-player or team modes where jackpot eligibility includes multiple participants simultaneously, with distribution configured as winner-take-all, pro-rated by number of entries, or split evenly among active participants.

In a sixth embodiment, an operator interface allows facility managers to configure target parameters, jackpot contribution percentages, verification thresholds, reset values, lighting behavior, time-of-day adjustments, weather-based adjustments, and eligibility restrictions. The rules engine operates locally or via a cloud-based administration system. In a seventh embodiment, the system operates via software that integrates with pre-existing tracking platforms through API calls or data interpretation of existing ball-flight metrics, requiring no additional hardware.

In an eighth embodiment, the system deploys dedicated hardware including illumination modules, hit detection sensors, embedded target electronics, bay-mounted touchscreens, RFID-enabled golf balls, and audible or visual win indicators. In a ninth embodiment, users join the jackpot game remotely via mobile devices, enabling pre-payment, jackpot viewing, and account-based prize distribution across multiple facilities with a networked jackpot that grows across all participating locations. In a tenth embodiment, the system maintains multiple jackpots simultaneously with daily, weekly, and monthly tiers, where a single shot qualifies for one or more tiered prize pools depending on predefined rules.

Returning to the description of the lighting and control system, the golf range lighting system comprises multiple subsystems working in concert to provide advanced lighting control and integration capabilities. The primary subsystems include:

The system employs LED lighting units capable of variable intensity and color output. Each unit includes:
High-efficiency LED arrays
Multiple optical lenses within a single light unit, configured to focus at different distances
Color mixing capabilities
Integrated heat management systems
A weather-resistant housing
Motor-driven positioning mechanisms
Wireless communication modules
An optional spirit bubble level mounted on the housing to ensure correct orientation

The multiple lens configuration enables simultaneous illumination of both near and distant targets. For example, one lens may be configured to focus at 50 yards while another lens focuses at 200 yards, providing optimal illumination across the entire range area.

The tablet-based control interface provides:
Touch-screen operation
Real-time status monitoring
Preset configuration storage
User authentication
System diagnostics
Usage logging

The wireless infrastructure includes:
Central server
Mesh network capabilities
Redundant communication paths
Error detection and correction
Security protocols
Bandwidth management

In all embodiments, the system provides basic lighting control through the tablet interface. This configuration includes:

Power Control:
Individual light switching
Group control capabilities
Scheduled operation
Emergency shutdown features

Dimming Control:
256 levels of intensity
Group dimming
Scene presets
Fade timing control

Color Selection:
RGB color mixing
Preset color schemes
Dynamic color changes
Temperature correction

In the first embodiment of the light fixture, the lights are installed in a fixed position. This is useful for illuminating targets that will not move, or for illuminating fixed physical structures such as bays. The spirit level is integrated into the hardware to allow for easy mounting. The intensity and colors of the light can be controlled remotely.

In the second embodiment of the light fixture, the lights can be moved in a vertical direction—in other words, adjustable tilt. In the preferred embodiment with three floodlight modules, the tilt is adjustable for two of the three modules, with the third module being fixed.

Vertical adjustment includes:
Motor-driven height adjustment
Position feedback sensors
Collision avoidance
Programmable height limits

In the third embodiment of the light fixture, horizontal positioning is added, or panning via a power rotating base with a cantilevered bracket design:

Horizontal adjustment includes:
Power rotating base with step motor control
Cantilevered bracket system balancing the weight of the lights against the weight of the power supply
Position memory
Multi-axis coordination
Safety interlocks

The rotating base can provide various amounts of rotation.

In a first configuration, the rotating base provides 180 degrees of rotation, suitable for installations where the lights are mounted against a wall or structure.

In a second configuration, the rotating base enables 270 degrees of rotation, appropriate for corner-mounted installations requiring broader coverage.

In a third configuration, the rotating base allows full 360-degree rotation, enabling complete coverage when the unit is mounted in a central location.

Each rotational configuration includes:
Precision step motor control
Position memory storage
Programmable rotation limits
Automatic position calibration
Emergency stop capabilities

Lighting position and control is managed through an API, or application programming interface. By tracking the balls, and establishing a rule set, certain conditions will cause certain reactions. For example, a ball hitting a target can cause a preprogrammed set of light color changes and movements to indicate target contact.

The lighting system anticipates working with multiple ball tracking technologies. These include, for example: p Camera-Based Tracking Configuration:
Multiple high-speed cameras positioned throughout the range
Computer vision processing for ball detection and trajectory calculation
Real-time position and trajectory analysis
An ability to track multiple balls simultaneously

Radar-Based Tracking Configuration:
Doppler radar systems for ball tracking
Precise velocity and trajectory measurements
All-weather tracking capabilities
Enhanced distance measurement accuracy

Hybrid Tracking Configuration:
Combined camera and radar tracking systems
Cross-validation of trajectory data
Enhanced accuracy through sensor fusion
Redundant tracking capabilities for reliable operation

Each tracking configuration interfaces with the lighting system through standardized APIs, enabling:

Target Illumination:
Real-time trajectory processing
Predictive lighting activation
Impact zone highlighting
Shot path visualization

Achievement Recognition:
Shot distance monitoring
Accuracy measurement
Prize eligibility tracking
Visual feedback generation

Additionally or separately, the lights can be integrated with bay occupancy management systems. By using different colors to indicate the status of a bay, players can see which bays are available, which bays are reserved, which bays are occupied, or which bays are closed for maintenance.

The lighting system provides versatile illumination solutions for both driving ranges and golf courses. On golf courses, the positioning capabilities enable precise light direction control, allowing targeted illumination of specific playing areas while minimizing light spillage into surrounding areas. This targeted approach reduces the number of high-mast lighting installations required for nighttime play, thereby lowering infrastructure costs and environmental impact. The system's tracking capabilities allow the lights to follow player positions throughout the course, providing optimal illumination while maintaining minimal light pollution. This adaptation to player location particularly benefits golf courses where traditional fixed lighting systems require extensive installations to achieve comparable coverage. The system thus serves both driving range applications, where fixed target areas are illuminated, and golf course applications, where dynamic lighting follows play progression.

The system optionally includes a closest-to-the-pin competition that leverages the ball tracking infrastructure to automatically measure and verify player performance. Players enroll through the bay interface, with the system designating a specific target location on the range as the pin position. The ball tracking system monitors the shots of each enrolled player, calculating the final landing distance with respect to the designated pin position. The system maintains a running leaderboard of participants ranked by closest approach distance. The lighting system illuminates the target pin location and provides visual feedback by changing color or intensity as players achieve closer approaches. At the conclusion of a competition period, which may be hourly, daily, weekly, or event-based, the system automatically identifies the winning player and initiates prize distribution.

The closest-to-the-pin competition operates in multiple configurations. In a first embodiment, the system designates a single fixed target location for all participants. In a second embodiment, the system rotates the designated pin location at predetermined intervals or after each successful shot meeting a distance threshold. In a third embodiment, the system operates multiple simultaneous closest-to-the-pin competitions at different target distances, allowing players to compete in different skill categories. In a fourth embodiment, the lighting units illuminate concentric zones around the pin location using different colors, with zone colors indicating scoring tiers or prize levels. In a fifth embodiment, when a player achieves a distance closer than the current leader, the lighting system activates celebratory effects at the player's bay and at the target location.

The system optionally includes a long drive competition that uses the ball tracking system to measure and verify maximum driving distances. Players enroll through the bay interface, with the system monitoring all shots from enrolled participants. The ball tracking system calculates total carry distance, total distance including roll, or both, for each shot. The system maintains a real-time leaderboard displaying the longest drives within defined competition periods. The lighting system provides visual indicators of distance achievements by illuminating distance markers or target zones corresponding to exceptional drive lengths. When a player achieves a drive exceeding the current longest distance, the lighting system activates celebratory effects including color changes, sequential illumination patterns, or synchronized displays across multiple lighting units.

The long drive competition operates in multiple configurations. In a first embodiment, the system tracks absolute longest distance regardless of club selection. In a second embodiment, the system maintains separate leaderboards for different club categories, requiring players to designate club selection through the bay interface. In a third embodiment, the system operates tiered distance competitions with multiple prize levels awarded for distances exceeding predetermined thresholds. In a fourth embodiment, the lighting units change color, intensity, or pattern when shots exceed specific distance milestones, providing immediate visual feedback. In a fifth embodiment, the system operates head-to-head matchups where paired players compete directly, with the lighting system providing contrasting color displays indicating which player currently holds the advantage.

Both closest-to-the-pin and long drive competitions integrate with the progressive jackpot framework described above. In one configuration, a portion of entry fees contributes to separate jackpot pools for each competition type. In another configuration, players may purchase combined entry packages providing eligibility for hole-in-one, closest-to-the-pin, and long drive competitions simultaneously. The lighting system differentiates between active competition types through color coding, lighting patterns, or sequential displays that cycle through indicators for each active competition.

Further included in the golf range lighting control system is a specialty illuminated putting hole. The specialty illuminated putting hole operates as a bonus hole following completion of a putting course or as a standalone attraction within a driving range facility.

The specialty illuminated putting hole includes a putting cup recessed into a putting surface and one or more illumination elements positioned within, around, beneath, or adjacent to the cup. The illumination elements preferably comprise light-emitting diodes (LEDs. Illumination emanates upward from within the cup, radially around a rim or collar of the cup, downward or outward from surrounding architectural or decorative structures, or from combinations thereof.

The illumination system is automatically activated when a player approaches or enters a designated putting area. Activation mechanisms include pressure sensors beneath the putting surface, motion sensors, proximity sensors, optical sensors, infrared sensors, wireless detection of player presence, confirmation of fee payment, or manual activation by an operator or control system. Upon activation, the illumination transitions from a dormant or low-visibility state to an active, high-visibility state intended to alert spectators that a putting attempt is imminent.

In some embodiments, the illumination system synchronizes with audio effects, announcements, digital displays, scoreboards, timers, countdown indicators, or prize indicators. The synchronization enhances the dramatic effect and spectator engagement associated with the putting attempt. A central control system manages illumination patterns, activation logic, fee validation, and optional prize logic. The control system adapts illumination behavior based on ambient lighting conditions, time of day, crowd presence, or promotional events.

Access to the specialty illuminated putting hole optionally requires payment of a fee. The specialty illuminated putting hole operates as a bonus hole attempted only after completion of a predefined putting course, where eligibility depends on course completion, score achievement, time requirements, or payment of an additional fee. In alternative embodiments, the specialty illuminated putting hole operates as a single, independent attraction within a driving range facility, where players access the putting hole by paying a fee either independently or in conjunction with bay usage. In embodiments incorporating prize features, multiple fees contribute to a prize pool or jackpot that accumulates and resets upon a successful putt.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a view of a selection of bays of a typical driving range of the golf range lighting system.

FIG. 2 illustrates a schematic view of the golf range lighting system.

FIG. 3 illustrates a first diagram of a light fixture of the golf range lighting system.

FIG. 4 illustrates a second diagram of a light fixture of the golf range lighting system.

FIG. 5 illustrates a third diagram of a light fixture of the golf range lighting system.

FIG. 6 illustrates a fourth diagram of a light fixture of the golf range lighting system.

FIG. 7 illustrates a fifth diagram of a light fixture of the golf range lighting system.

FIG. 8 illustrates a flowchart of the control system of the golf range lighting system.

FIG. 9 illustrates a view of the mobile interface of the golf range lighting system.

FIG. 10 illustrates a flowchart of the hole-in-one jackpot game enrollment and participation process of the golf range lighting system.

FIG. 11 illustrates a flowchart of the shot verification and prize distribution process of the golf range lighting system.

FIG. 12 illustrates a flowchart of the progressive jackpot accumulation and reset process of the golf range lighting system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

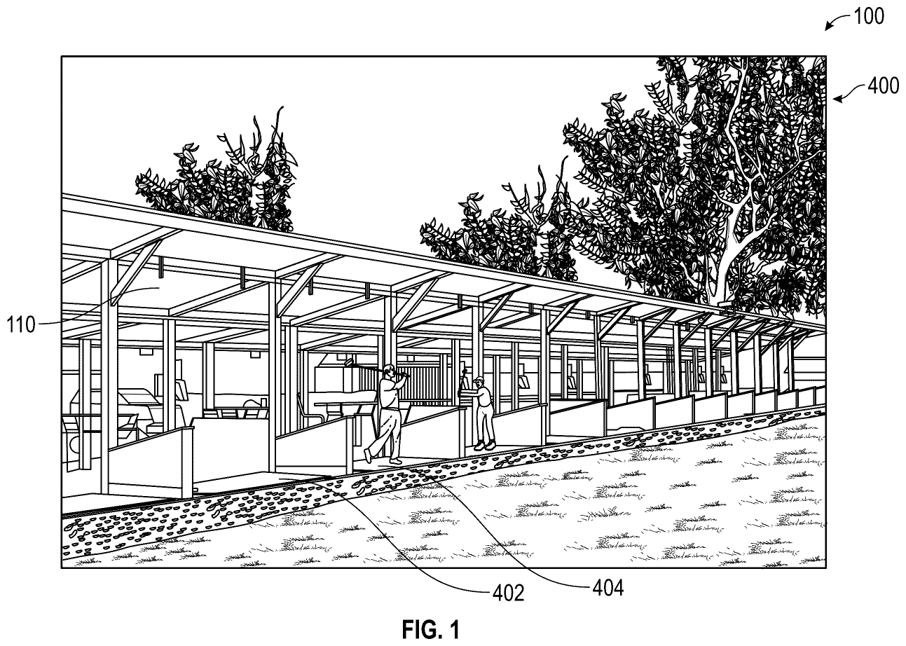

Referring to FIG. 1, a view of a selection of bays of a typical driving range of the golf range lighting system is shown.

The golf range lighting system 100 is shown with example light fixtures 110 installed within bays 402 of a driving range 400. Each bay 402 includes a tee-off position 404, where a player can stand.

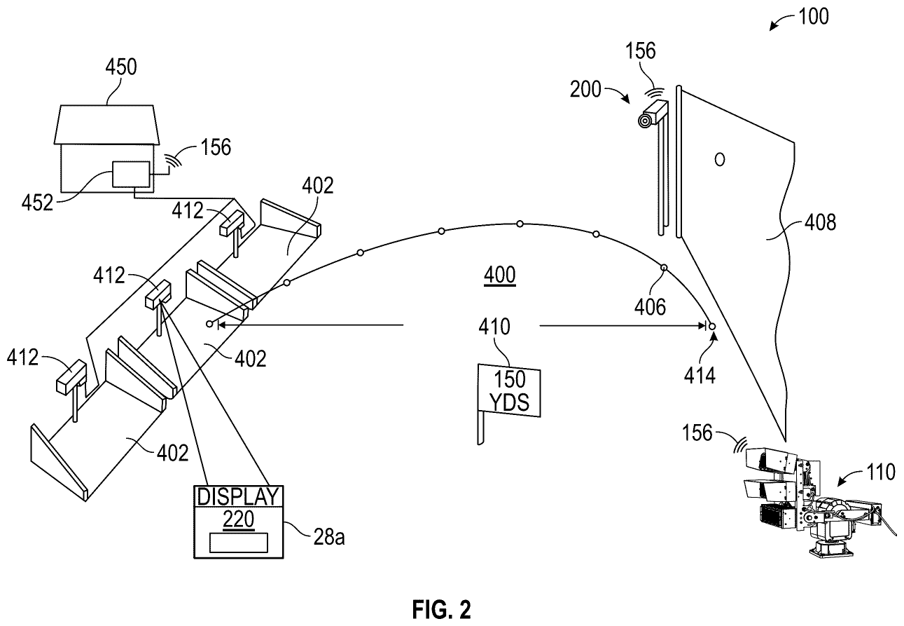

Referring to FIG. 2, a schematic view of the golf range lighting system is shown.

The driving range 400 includes multiple bays 402. Each bay 402 includes an optional display 412 with text and images 220 allowing the golfer to interact with the golf range lighting system 100.

When a golf ball 406 is hit, its position is tracked by, for example, sensor 200. Sensor 200 communicates via wireless communication 156 with the control cabinet 450 that includes control electronics 452. Control electronics 452 can provide processing, or can interface with cloud applications via the Internet to process the data presented by the sensors 200. A net 408 prevents the ball 406 from flying too far.

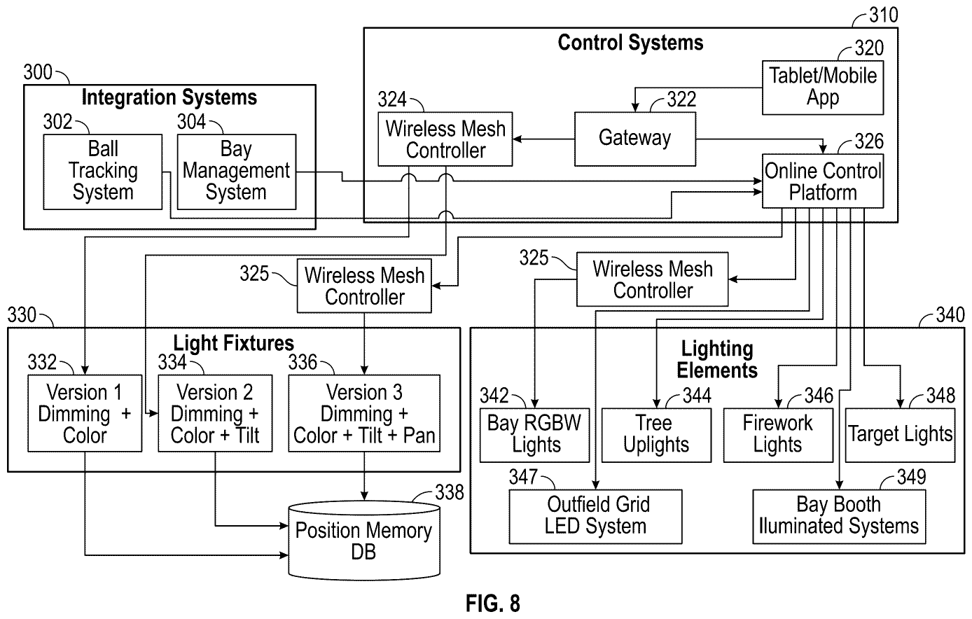

The control electronics 452 calculates the predicted impact zone by applying ballistic trajectory equations to the trajectory data received from the ball tracking system 302(see FIG. 8). The calculation employs initial velocity measurements, launch angle measurements, and spin rate data to determine a predicted flight path. The control electronics 452 applies environmental correction factors including wind speed data, air density measurements, and temperature measurements obtained from sensors 200 positioned throughout the driving range 400. The predicted impact zone comprises a circular area with a radius calculated based on the confidence of the prediction.

By determining the position of the golf ball 406 and the golf ball end point 414, certain behaviors are triggered. For example, motion of lights, color changes, or flashing patterns. These instructions are passed to the one or more light fixtures 110 via wireless communication 156. Behaviors can triggered when, for example, the golf ball 406 passes certain markers 410, or contacts or lands within a certain distance of the marker 410.

For example, shot path visualization and lighting. The golf range lighting system 100 optionally employs a grid system where the control electronics 452 maintains a coordinate database associating each light fixture 110 with a specific geographic location on the driving range 400. As the ball tracking system 302 (see FIG. 8) transmits position data indicating the golf ball 406 has entered a geographic zone associated with a specific light fixture 110, the control system 310 activates the light fixture 110 for a predetermined display duration. The control system 310 compares the golf ball 406 position coordinates to the coordinate database at update intervals ranging from 10 milliseconds to 100 milliseconds, determining which light fixture 110 is nearest to the current ball position. The sequential activation creates the visual representation by illuminating successive light fixtures 110 as the golf ball 406 progresses through corresponding geographic zones from the bay 402 to the golf ball end point 414.

When multiple golf balls 406 are simultaneously in flight, the ball tracking system 302 maintains unique tracking identifiers for each golf ball 406. The ball tracking system 302 associates each detected ball launch with the originating bay 402 based on the launch position coordinates. The control electronics 452 maintains separate trajectory calculation processes for each tracked golf ball 406, tagging each trajectory data transmission with a bay identifier. The control system 310(see FIG. 8) employs the bay identifier to determine appropriate lighting responses, where the light fixture 110 associated with each bay 402 displays a unique color corresponding to the bay identifier. When trajectory data for multiple golf balls 406 indicates overlapping predicted impact zones, the control system 310 activates the light fixtures 110 in the overlapping zone using color mixing to simultaneously represent multiple balls, or using time-division multiplexing where the light fixtures 110 rapidly alternate between colors associated with different bay identifiers to create apparent simultaneous display.

The plurality of light fixtures 110 are distributed across the driving range 400 in a spatial arrangement providing overlapping coverage zones. In a first embodiment, the light fixtures 110 are positioned at regular intervals along the perimeter of the driving range 400 at spacing ranging from 50 feet to 150 feet, with each light fixture 110 providing illumination coverage of a sector ranging from 30 degrees to 90 degrees. In a second embodiment, the light fixtures 110 are positioned adjacent to each marker 410, providing localized illumination of specific target zones. In a third distribution configuration, the light fixtures 110 are positioned on a grid pattern throughout the driving range 400 at spacing intervals ranging from 75 feet to 200 feet in both horizontal and vertical directions, creating a matrix of illumination zones where each geographic location on the driving range 400 is within range of at least two light fixtures 110 to enable redundant coverage.

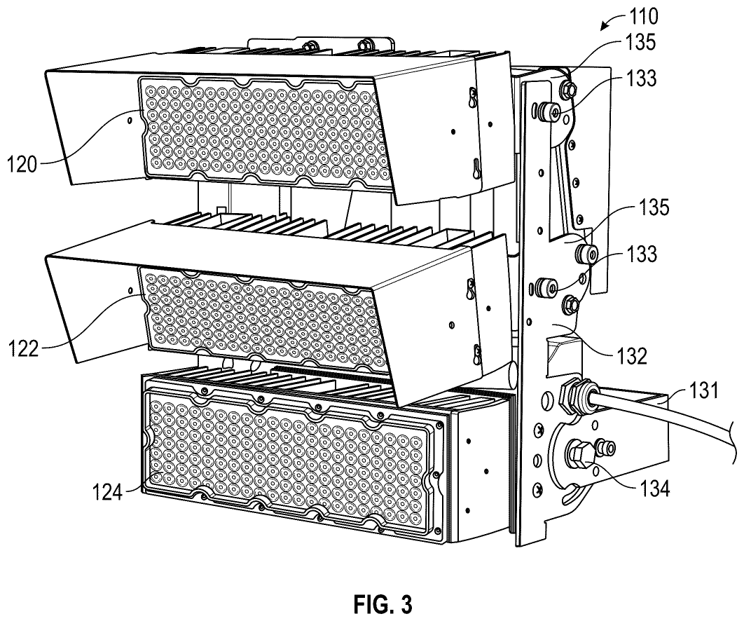

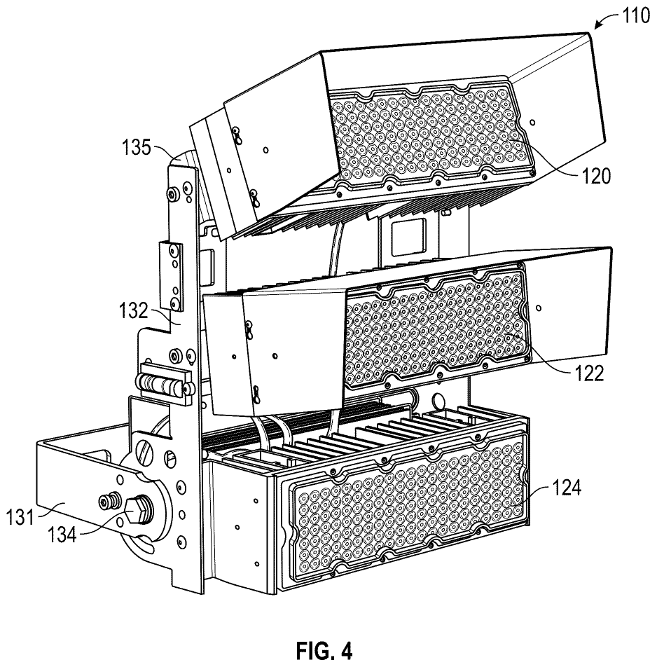

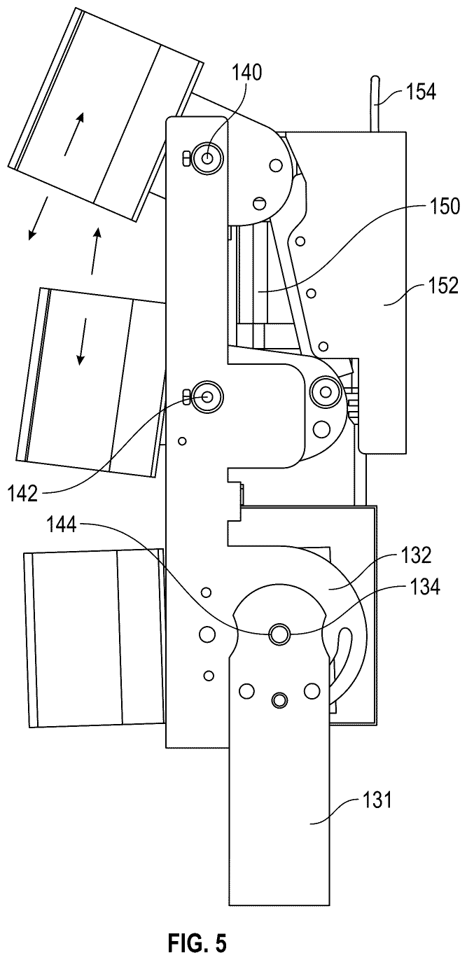

Referring to FIGS. 3, 4, and 5, first, second, and third diagrams of a light fixture of the golf range lighting system are shown.

The light fixture 110 includes the main bracket 131, which connects to an extension bracket 132. A first floodlight 120, second floodlight 122, and a third floodlight 124 are connected to the extension bracket 132 at pivots 133. In this embodiment, the third floodlight 124 has a locking pivot point 134. The first floodlight 120 and the second floodlight 122 have adjustable tilt angles, controlled by actuator 150. Actuator 150 is instructed by the communication and control module 152 that communicates via the antenna 154.

Each floodlight is connected to the extension bracket 132 by a fixture bracket 135. The fixture brackets 135 rotate with respect to the extension bracket 132 at separate pivots, specifically a first floodlight pivot 140, a second floodlight pivot 142, and third floodlight pivot 144.

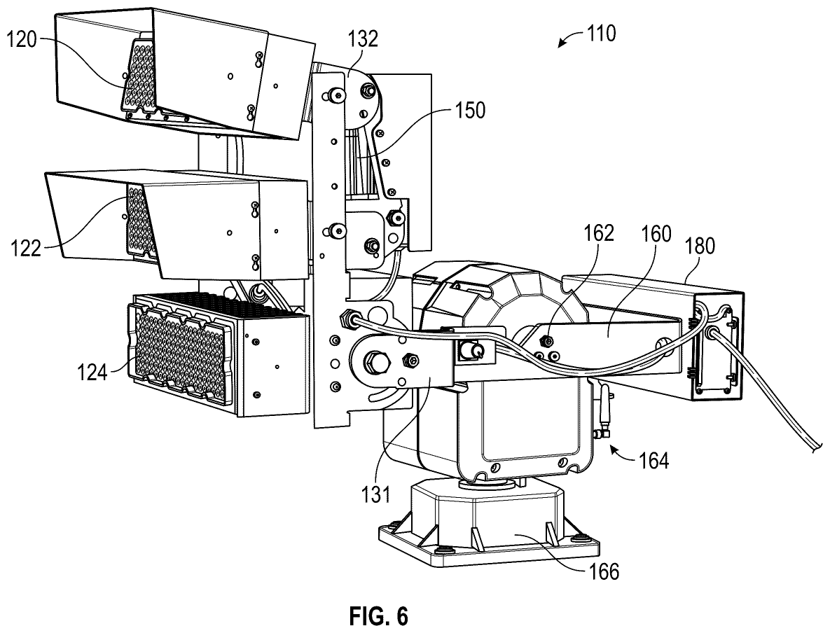

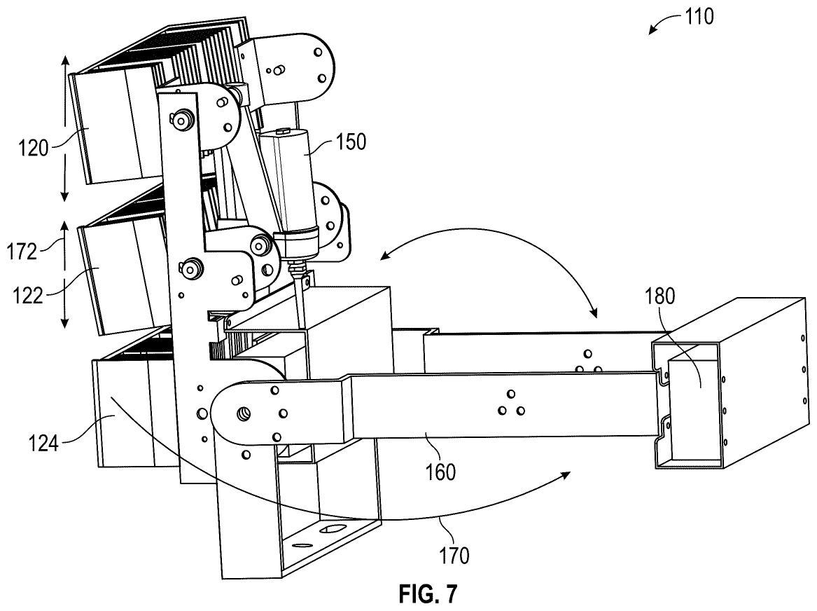

Referring to FIGS. 6 and 7, fourth and fifth diagrams of a light fixture of the golf range lighting system are shown.

In this embodiment, a powered rotating base 164, affixed to mounting plate 166, has been added to the light fixture 110. In this embodiment, in addition to vertical rotation 172, the light fixture 110 has horizontal rotation 170.

In this embodiment, the first floodlight 120 and second floodlight 122 remain controlled by actuator 150, where the third floodlight 124 remains fixed with respect to the extension bracket 132.

The main bracket 131 now connects to a cantilevered support bracket that is connected to the power rotating base at the cantilevered support bracket pivot 162. The power supply 180 is placed at the end of the cantilevered support bracket 160, providing a balancing force to the collective weight of the floodlights.

Referring to FIG. 8, a flowchart of the control system of the golf range lighting system is shown.

This figure describes the interaction between the various systems that track ball position and control lighting.

Integration systems 300 include the ball tracking system 302 and the bay management system 304. The information gathered by these systems, such as the position of the ball and whether a bay is occupied, inform downstream systems that determine the appropriate lighting behaviors to trigger.

Control systems 310 accept and organize the data to finalize the appropriate lighting fixture reactions. Information from the integration systems 300 flows to the online control platform 326 in combination with information from the mobile app 320 which passes through gateway 322 before being shared with the wireless mesh controller 324 and the online control platform 326.

Data then passes through either the first wireless mesh controller 324 or second wireless mesh controllers 325, before being communicated with the light fixtures 330 and/or lighting elements 340.

Light fixtures 330 include a first version 332 with dimming and color control, a second version 334 with dimming, color, and tilt control, and third version with dimming, color, tilt, and pan control 336.

An optional position memory database 338 stores lighting position information or referenced by the light fixtures 330. In this way the instructions from the online control platform 326 can reference a particular stored position, such as the “Hole-in-one” position, rather than sending complete movement instructions each time.

Additionally, certain less-sophisticated lighting elements 340 can be present within the system, including bay lighting 342, tree lighting 344, fireworks lighting 346, target lights 348, outfield grid LED signs 347, and bay booth illuminated signs 349.

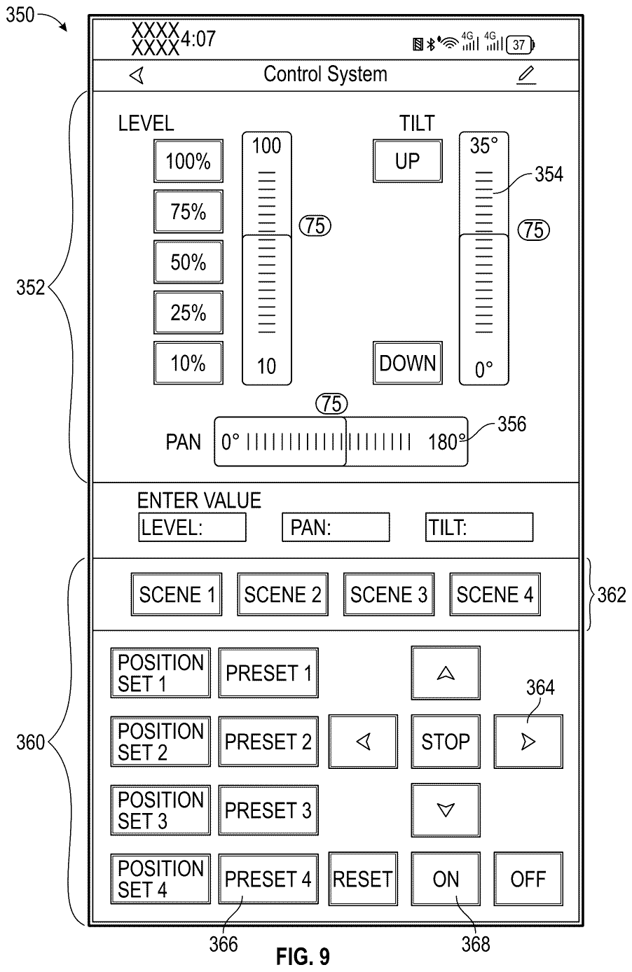

Referring to FIG. 9, a view of the mobile interface of the golf range lighting system is shown.

The mobile app interface 350 includes multiple controls. These control systems can be used to override preprogrammed rules, or to set new scenes or positions.

For example, a user can set the intensity of the lighting using the lighting level 352, as well as the tilt 354 and pan 356 positions. This information can then be used to create preset scenes 362 within the scene selection 360 section of the interface.

Combined with the lighting intensity and lighting further combined with position control 364 information, the user can choose from preset positions 366, or save new positions into the presets. Additionally, power control 368 for a given lighting fixture is available.

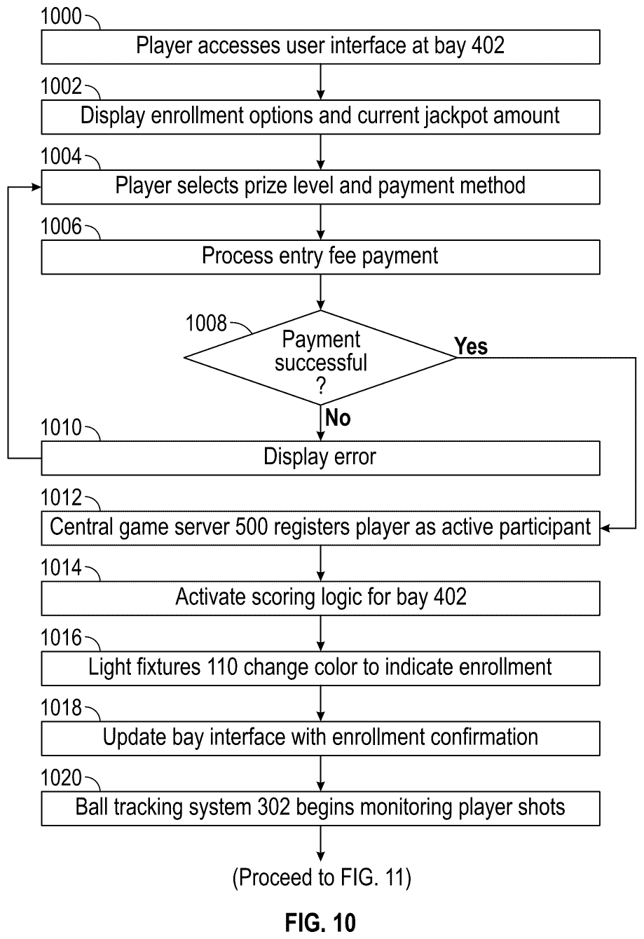

Referring to FIG. 10, a flowchart of the hole-in-one jackpot game enrollment and participation process of the golf range lighting system is shown.

The hole-in-one jackpot game enrollment process begins when a player accesses a user interface at an assigned hitting bay, 1000. The user interface is provided through a touchscreen terminal, a mobile device interface, or an electronic display operatively connected to the golf range lighting system 100. The interface prompts the player to elect participation in the jackpot game by paying, for example, a fixed entry fee, a variable fee, or a subscription fee, 1002. The enrollment interface enables selection of different prize levels, differing target difficulty modes, or access to promotional jackpots. The interface displays the current jackpot amount, recent winners, and game rules. The interface further provides options for multi-player or team enrollment, where multiple players at a single bay or across multiple bays can participate collectively.

The user selects a prize level and the method of payment, 1004. The payment is then processed, 1006. An error in payment 1010 causes an error to be displayed, and a return to step 1004.

Upon successful payment processing 1008, a central game server 500 registers the player as an active participant, 1012. The central game server 500 activates scoring logic for the bay 402 associated with the enrolled player, 1014. Participation is limited to a defined time period, a predetermined number of shots, or open play until the player deselects the game through the interface.

The central game server 500 communicates enrollment status to the control system 310 (see FIGS. 8), 1014. The light fixtures 110 change color, intensity, or pattern to indicate active participation status, 1016. For example, the light fixture 110 associated with an enrolled player's bay 402 displays a distinctive color, such as blue or green, to visually distinguish active participants from non-participants, 1018.

The ball tracking system 302 then begins to monitor players shots, 1020.

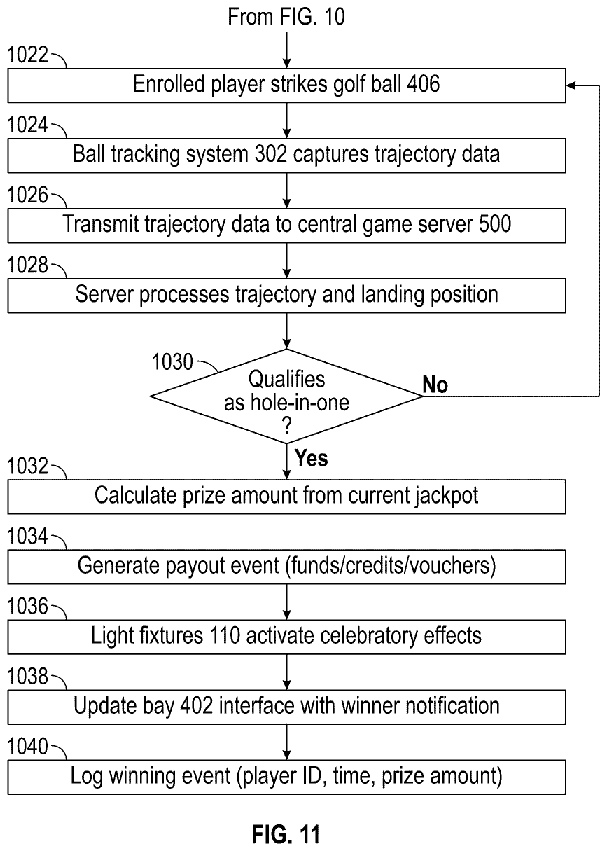

Referring to FIG. 11, a flowchart of the shot verification and prize distribution process of the golf range lighting system is shown.

The shot verification process begins when an enrolled player strikes a golf ball 406, 1022. The ball tracking system 302 employs camera-based tracking, radar-based tracking, or hybrid tracking to determine ball launch characteristics, trajectory, and landing location in real time, 1024. The ball tracking system 302 transmits trajectory data to the central game server 500 via wireless communication 156, 1026

The central game server 500 processes the trajectory data to determine whether the golf ball 406 qualifies as a hole-in-one event, 1028. A hole-in-one event is defined as the golf ball 406 entering a physical or virtual target zone.

In one embodiment, the target zone comprises a physical structure featuring one or more receptacles, rings, or detection boundaries. In another embodiment, the target zone is defined in software as a set of GPS coordinates or coordinate boundaries stored in memory.

Verification of a qualifying shot requires one or more criteria. The golf ball 406 enters a defined receptacle. The golf ball 406 intersects with a sensor array. The golf ball 406 passes through an optical detection field or an infrared detection field. Software determines the golf ball 406 landed within a virtual target zone. In some embodiments, multi-sensor verification is used to improve accuracy. For example, radar determines initial velocity and trajectory while cameras confirm final landing coordinates.

The system must then determine whether or not the shot qualifies as a hole-in-one, 1030. If the shot is not a hole-in-one, the system loops back to step 1022.

If the shot qualifies as a hole-in-one event, the central game server 500 initiates a prize distribution sequence. The central game server 500 calculates the prize amount based on the current jackpot value, 1032. The central game server 500 generates a payout event, which includes issuing funds, digital credits, loyalty points, gift certificates, or automated payouts through a mobile application or third-party payment processor, 1034.

The central game server 500 communicates the winning event to the light fixtures 110. The light fixtures 110 activate celebratory lighting effects, 1036. The celebratory lighting effects include color changes, pulsing patterns, strobing patterns, cascading lights, animated sequences, or brightness modulation. The lighting effects are synchronized across multiple targets, multiple bays, or an entire facility to create a unified celebratory display. The light fixtures 110 illuminate the target area where the hole-in-one occurred, highlight the bay 402 of the winning player, and display special patterns indicating prize distribution, 1038.

The central game server 500 updates the user interface at the winning player's bay 402 to display a congratulatory message, the prize amount, and instructions for prize collection. The central game server 500 logs the winning event, including player identification, timestamp, prize amount, and trajectory data, for audit and reporting purposes, 1040.

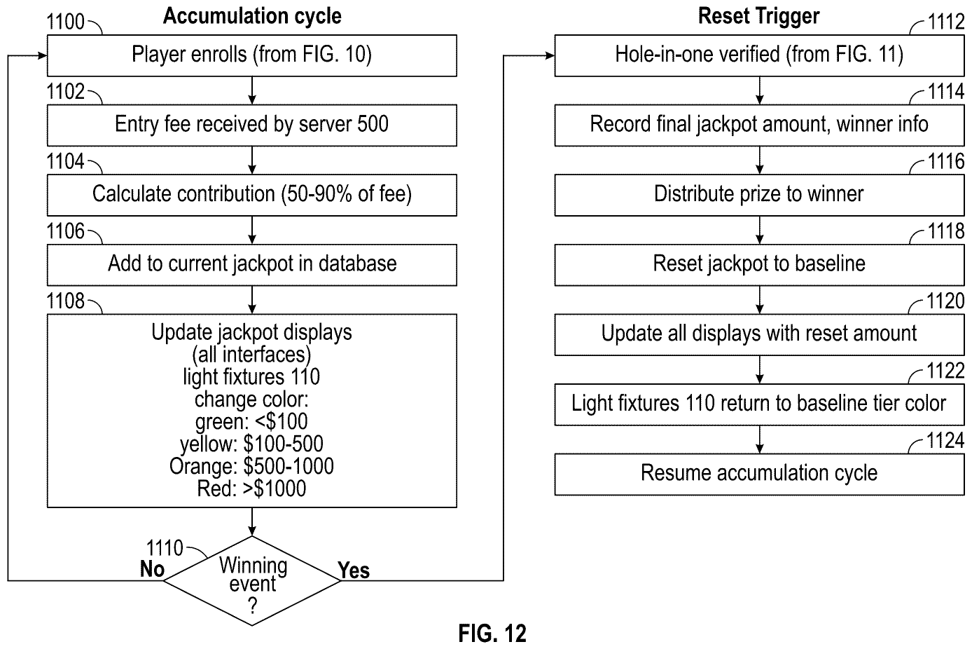

Referring to FIG. 12, a flowchart of the progressive jackpot accumulation and reset process of the golf range lighting system is shown.

The optional progressive jackpot accumulation process operates continuously during facility operation. Each time a player enrolls in the hole-in-one jackpot game, 1100, through the enrollment process described in FIG. 10, the central game server 500 receives the entry fee payment, 1102. The central game server 500 calculates a predetermined portion of the entry fee designated for jackpot contribution, 1104. This predetermined portion is configurable by facility operators and typically ranges from 50% to 90% of the entry fee.

The central game server 500 adds the calculated contribution amount to the current jackpot value stored in a database, 1106. The database maintains the current jackpot amount, historical jackpot amounts, contribution history, and winner information. The central game server 500 updates the current jackpot display across all connected interfaces, including bay-level user interfaces, centralized displays, mobile devices, and light fixtures 110.

The light fixtures 110 indicate jackpot size through visual representations, 1108. The color of the light fixtures 110 changes based on jackpot tier thresholds. For example, the light fixtures 110 display green for jackpot values below $100, yellow for values between $100 and $500, orange for values between $500 and $1000, and red for values exceeding $1000. The intensity of the light fixtures 110 increases proportionally with jackpot value, providing intuitive visual feedback to players regarding prize magnitude.

The system then monitors for a winning event, 1110.

When no qualifying hole-in-one event occurs, the jackpot continues to accumulate with each new participant enrollment. The central game server 500 continuously monitors the jackpot value and updates all display interfaces in real time. The system creates anticipation and engagement as players observe the increasing jackpot value.

Upon verification of a winning hole-in-one event as described in FIG. 11, the central game server 500 initiates the jackpot reset process, 1112. The central game server 500 records the final jackpot amount, winner information, and timestamp, 1114. The central game server 500 distributes the jackpot prize to the winning player through the configured payout method, 1116. The central game server 500 resets the jackpot value to a predetermined baseline amount, 1118.

The predetermined baseline amount is configurable by facility operators and typically ranges from $50 to $250. The baseline amount provides an initial attractive prize value to encourage continued participation immediately following a jackpot win. The central game server 500 updates all display interfaces to reflect the reset jackpot amount, 1120. The light fixtures 110 return to the visual representation associated with the baseline jackpot tier, 1122.

The accumulation process resumes immediately following the reset, 1124. The central game server 500 begins adding contributions from subsequent player enrollments to the reset baseline amount. The progressive jackpot cycle continues indefinitely during facility operation, creating recurring opportunities for players to participate and win escalating prizes.

In embodiments with multiple simultaneous jackpots, the central game server 500 maintains separate accumulation and reset processes for each jackpot tier. Daily jackpots, weekly jackpots, and monthly jackpots operate independently, each with dedicated contribution percentages, baseline amounts, and display interfaces. A single shot qualifying for multiple jackpot tiers triggers separate prize distributions for each applicable tier.

In multi-location embodiments, the central game server 500 coordinates jackpot accumulation across multiple facilities. Each facility contributes to a shared networked jackpot pool. The networked jackpot displays across all participating locations, creating larger prize pools and enhanced player engagement. A qualifying hole-in-one at any participating facility triggers jackpot distribution and simultaneous reset across the entire network.

The hole-in-one jackpot game operates in multiple configurations to accommodate different facility requirements and player preferences. In a first configuration, the system employs a progressive jackpot model where each entry contributes a predetermined portion to a cumulative prize pool. The prize pool displays at individual bays, centralized displays, mobile devices, and via lighting effects on or near targets.

Equivalent elements can be substituted for the ones set forth above such that they perform in substantially the same manner in substantially the same way for achieving substantially the same result.

What is claimed is:

1. A golf range lighting system, comprising:
a ball tracking system configured to track golf ball trajectories and transmit trajectory data during ball flight;
a plurality of lighting units positioned at target areas on a golf range;
a control system operatively connected to the ball tracking system and the plurality of lighting units, wherein the control system:
receives the trajectory data from the ball tracking system during flight of a golf ball;
calculates a predicted impact zone based on the trajectory data while the golf ball remains airborne;
activates one or more lighting units associated with the predicted impact zone before the golf ball reaches the predicted impact zone.

2. The system according to claim 1, wherein the control system activates the one or more lighting units by adjusting at least one of:
color output;
intensity level; or
position of the one or more lighting units.

3. The system according to claim 2, wherein the control system adjusts the color output to a first color during ball flight and changes to a second color after the golf ball lands within the predicted impact zone.

4. The system according to claim 1, wherein the ball tracking system comprises:
one or more cameras configured to capture ball flight data; or
one or more radar units configured to capture ball flight data.

5. The system according to claim 4, wherein the ball tracking system comprises a hybrid tracking configuration including both the one or more cameras and the one or more radar units.

6. The system according to claim 1, wherein at least one lighting unit of the plurality of lighting units comprises:
a main bracket;
an extension bracket connected to the main bracket;
a first floodlight connected to the extension bracket at a first floodlight pivot;
a second floodlight connected to the extension bracket at a second floodlight pivot;
a third floodlight connected to the extension bracket at a third floodlight pivot;
actuators connected to the first floodlight and the second floodlight, the actuators enable vertical rotation of the first floodlight and the second floodlight, the third floodlight remaining in a fixed position relative to the extension bracket;
a powered rotating base operatively connected to the main bracket, the powered rotating base enables horizontal rotation of the main bracket, the extension bracket, the first floodlight, the second floodlight, and the third floodlight.

7. The system according to claim 1, further comprising:
a wireless mesh network operatively connecting the control system to the plurality of lighting units;
wherein the control system transmits control signals to the one or more lighting units through the wireless mesh network.

8. The system according to claim 1, wherein the control system:
determines a predicted landing distance based on the trajectory data;
activates lighting units associated with distance markers corresponding to the predicted landing distance.

9. The system according to claim 1, further comprising:
a bay management system operatively connected to the control system;
wherein the control system associates the trajectory data with a specific bay based on data from the bay management system;
wherein the control system activates the one or more lighting units in a color associated with the specific bay.

10. The system according to claim 1, wherein the plurality of lighting units comprise:
LED arrays capable of variable intensity output;
motorized positioning mechanisms;
wherein the control system adjusts position of the one or more lighting units to direct illumination toward the predicted impact zone.

11. The system according to claim 10, wherein the motorized positioning mechanisms comprise:
a powered rotating base enabling horizontal rotation;
actuators enabling vertical rotation.

12. A golf range lighting system, comprising:
a ball tracking system configured to monitor a position of a golf ball throughout a flight path, and the ball tracking system transmitting position data;
a plurality of lighting units distributed across a golf range;
a control system operatively connected to the ball tracking system and the plurality of lighting units;
wherein the control system:
receives the position data from the ball tracking system during flight of the golf ball;
determines a sequence of the plurality of lighting units corresponding to the flight path based on the position data;
sequentially activates the plurality of lighting units along the flight path to create a visual representation of ball trajectory from a launching position to a landing location.

13. The system according to claim 12, wherein the plurality of lighting units comprise:
LED arrays capable of variable intensity output;
wireless communication modules;
wherein the plurality of lighting units are controllable through a tablet interface to adjust power state, dimming level, and color output.

14. The system according to claim 13, wherein the plurality of lighting units further comprise:
LED arrays capable of variable intensity output;
wireless communication modules;
vertical positioning control comprising motor-driven tilt adjustment mechanisms;
horizontal positioning control comprising a powered rotating base;
wherein the plurality of lighting units are each programmable through the tablet interface to adjust power state, dimming level, color output, vertical position, and horizontal position.

15. The system according to claim 14, wherein the horizontal positioning control further comprises:
a cantilevered support bracket connected to the powered rotating base at a pivot point;
a power supply positioned at an end of the cantilevered support bracket opposite from the LED arrays;
wherein the power supply provides a balancing force to the weight of the LED arrays.

16. The system according to claim 12, further comprising:
a hole-in-one game system operatively connected to the control system, wherein the hole-in-one game system:
monitors the position data and landing location for enrolled players;
determines when the landing location indicates the golf ball has entered a designated hole-in-one target zone;
automatically initiates a prize distribution event when the golf ball has entered the designated hole-in-one target zone.

17. The system according to claim 16, wherein the control system:
receives eligibility data from the hole-in-one game system indicating which bays have enrolled players;
activates lighting units associated with enrolled bays, of the plurality of lighting units, in a distinctive pattern indicating active participation in a hole-in-one game.

18. The system according to claim 12, further comprising:
a bay management system operatively connected to the control system through an API interface, the control system:
receives bay status data through the API interface;
assigns a unique color to each status type, the unique colors comprise:
a first color indicating an available status;
a second color indicating a reserved status;
a third color indicating an occupied status; and
a fourth color indicating a maintenance status.

19. The system according to claim 12, wherein at least one lighting unit of the plurality of lighting units comprises:
a main bracket;
an extension bracket connected to the main bracket;
a first floodlight connected to the extension bracket at a first floodlight pivot;
a second floodlight connected to the extension bracket at a second floodlight pivot;
a third floodlight connected to the extension bracket at a third floodlight pivot;
actuators operatively connected to the first floodlight and the second floodlight, wherein the actuators enable vertical tilting of the first floodlight and the second floodlight, the third floodlight remains in a fixed position relative to the extension bracket;
a powered rotating base operatively connected to the main bracket, the powered rotating base enables horizontal rotation of the main bracket, the extension bracket, the first floodlight, the second floodlight, and the third floodlight.

20. A golf range lighting system, comprising:
a ball tracking system comprising:
multiple high-speed cameras positioned throughout a golf range;
radar systems positioned throughout the golf range;
computer vision processing for ball detection and trajectory calculation from the cameras;
the ball tracking system configured to provide cross-validated trajectory data from both the cameras and the radar systems during flight of a golf ball;
a plurality of lighting units positioned at target areas on the golf range, wherein at least one lighting unit comprises:
a main bracket;
an extension bracket connected to the main bracket;
one or more floodlights that each include an LED array, each LED array capable of variable intensity output and variable color output;
actuators operatively connected to each of the one or more floodlights, the actuators enabling vertical rotation;
a powered rotating base connected to the main bracket, the powered rotating base enabling horizontal rotation;
a cantilevered support bracket connected to the powered rotating base at a cantilevered support bracket pivot, wherein the main bracket is connected to the cantilevered support bracket;
a control system connected to the ball tracking system and the plurality of lighting units, the control system:
receives the cross-validated trajectory data from the ball tracking system during flight of the golf ball;
calculates a predicted impact zone based on the cross-validated trajectory data while the golf ball remains airborne;
calculates a direction toward the predicted impact zone;
transmits control signals to the communication and control module to adjust the horizontal rotation via the powered rotating base and the vertical rotation via the actuators to direct illumination from one or more floodlights toward the predicted impact zone;
activates the first LED array, the second LED array, and the third LED array with a selected color output and intensity level before the golf ball reaches the predicted impact zone.
